(19) United States
(12) Patent Application Publication
(10) Pub. No.: US 2021/0321008 A1
(43) Pub. Date: Oct. 14, 2021

(54) PRINT CONTROL METHOD AND NON-TRANSITORY COMPUTER-READABLE STORAGE MEDIUM STORING PRINT CONTROL PROGRAM

(71) Applicant: SEIKO EPSON CORPORATION, Tokyo (JP)

(72) Inventor: Masaru KAI, Matsumoto-shi (JP)

(21) Appl. No.: 17/228,107

(22) Filed: Apr. 12, 2021

(30) Foreign Application Priority Data
Apr. 13, 2020 (JP) 2020-071541

(51) Int. Cl. H04N 1/00; G06F 3/12; G06K 15/02

(52) U.S. Cl. CPC H04N 1/0048; H04N 1/00488; G06F 3/1234; H04N 1/00482; G06K 15/1805; G06F 3/1204; G06F 3/1258

(57) ABSTRACT

A control section of a personal computer receives input of a print command, a setting item, and identification information configured to identify a printer to which the setting item is set using character input, displays, when a display key is held down after the input of the print command, the setting item, and the identification information is received, a settable range related to a setting value of the setting item, and receives input of the setting value.

The present application is based on, and claims priority from JP Application Serial Number 2020-071541, filed Apr. 13, 2020, the disclosure of which is hereby incorporated by reference herein in its entirety.

### BACKGROUND

### 1. Technical Field

The present disclosure relates to a print control method and a non-transitory computer-readable storage medium storing a print control program.

### 2. Related Art

In the past, there has been known a technology of setting a variety of setting values of corresponding setting items to a device such as a printing device.

For example, in JP-A-2009-59027 (Document 1), there is described a setting screen for the setting values using a command-line interface, and there is described a configuration in which the setting screen is displayed for each of the setting items, and the setting value for the item selected with a cursor is changed.

However, the configuration described in Document 1 results in generation of the setting screen for each of the setting items or the setting functions, and the setting screen is a virtually a GUI (Graphical User Interface). Therefore, the degree of freedom of input as a CUI (Character User Interface) deteriorates.

### SUMMARY

An aspect for solving the problem described above is directed to a print control method including the steps of receiving input of a print command, a setting item, and identification information configured to identify the printing device to which the setting item is set using character input, displaying, when a predetermined first key is held down after the input of the print command, the setting item, and the identification information is received, a settable range related to a setting value of the setting item, and receiving input of the setting value.

Another aspect for solving the problem described above is directed to a non-transitory computer-readable storage medium storing a print control program making a processor function as a reception section configured to receive input of a print command, a setting item, and identification information configured to identify the printing device to which the setting item is set using character input, and a display control section configured to display, when a predetermined first key is held down after the input of the print command, the setting item, and the identification information is received, a settable range related to a setting value of the setting item, and making the reception section receive input of the setting value.

### BRIEF DESCRIPTION OF THE DRAWINGS

FIG. 1 is a diagram showing an example of a print system including a configuration of a personal computer.

FIG. 2A is a screen diagram showing an example of a settable range display instruction.

FIG. 2B is a diagram showing an example of a configuration of displaying settable ranges.

FIG. 2C is a screen diagram showing an example of the settable ranges.

FIG. 2D is a screen diagram showing an example of an error message.

FIG. 3 is a flowchart showing an example of processing in a control section.

### DESCRIPTION OF AN EXEMPLARY EMBODIMENT

An embodiment will hereinafter be described with reference to the drawings.

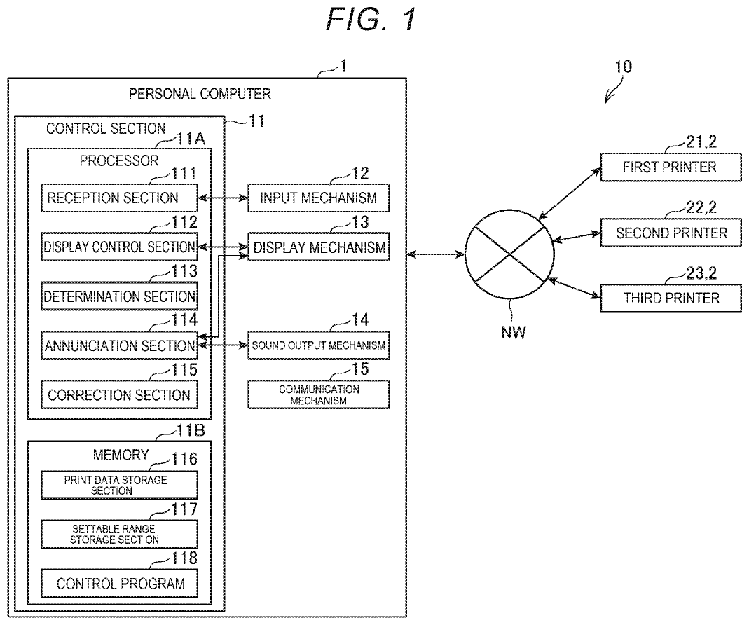

FIG. 1 is a diagram showing an example of a print system 10 including a configuration of a personal computer 1.

The personal computer 1 is coupled to a printer 2 via a network NW so as to be able to communicate with each other. The network NW is, for example, the Internet. The personal computer 1 outputs a print instruction to the printer 2 via the network NW. The printer 2 prints an image on a recording medium such as a print sheet in accordance with the print instruction from the personal computer 1. The printer 2 is provided with a print head of, for example, an inkjet type, and forms an image on the recording medium with ink ejected from the print head.

Although the printer 2 performs printing on the recording medium with an inkjet system in the present embodiment, it is possible for the printer 2 to perform printing on the recording medium by attaching toner to a printing surface with a so-called “electrophotographic system.”

Although the network NW is the Internet in the present embodiment, this is not a limitation. The network NW can be a LAN (Local Area Network), or can also be a WAN (Wide Area Network).

The printer 2 corresponds to an example of a “printing device.”

Although the “printing device” is the printer 2 in the present embodiment, this is not a limitation. The “printing device” can be a copy machine or can also be a complex machine having a facsimile function as long as a printing function is provided.

A printing system 10 in the present embodiment includes a first printer 21, a second printer 22, and a third printer 23. Here, the first printer 21, the second printer 22, and the third printer 23 are each described as a printer 2 when the printers 21, 22, and 23 are not distinguished from each other. The first printer 21, the second printer 22, and the third printer 23 are each assigned with identification information in advance. The identification information is an IP (Internet Protocol) address or a printer name.

The personal computer 1 determines the printer 2 to which the print instruction is to be output based on the identification information of the printers 2.

Although the printing system 10 includes the three printers in the present embodiment, this is not a limitation.

The personal computer 1 is provided with a control section 11, an input mechanism 12, a display mechanism 13, a sound output mechanism 14, and a communication mechanism 15.

The control section 11 controls operations of the personal computer 1.

The input mechanism 12 receives input from the user, generates an input signal corresponding to the input thus received, and then transmits the input signal to the control section 11. The input mechanism 12 includes, for example, a keyboard and a mouse.

The display mechanism 13 is provided with, for example, an LCD (Liquid Crystal Display) as a display screen, and displays a variety of images on the LCD in accordance with an instruction from the control section 11.

The sound output mechanism 14 is provided with, for example, a speaker, and outputs a variety of sounds from the speaker in accordance with an instruction from the control section 11.

The communication mechanism 15 communicates with the printers 2 via the network NW in accordance with an instruction from the control section 11. The communication mechanism 15 communicates with the printers 2 in accordance with, for example, the Ethernet (registered trademark) standard.

Although the communication mechanism 15 communicates with the printers 2 in accordance with the Ethernet (registered trademark) standard, this is not a limitation. It is possible for the communication mechanism 15 to communicate with the printers 2 using wireless communication such as Wi-Fi (registered trade mark).

The control section 11 is a controller provided with a processor 11A and a memory 11B.

The memory 11B is a storage device for storing programs and data to be executed by the processor 11A in a nonvolatile manner. The memory 11B is formed of a magnetic storage device such as an HDD (Hard Disk Drive), a semiconductor storage device such as an SSD (Solid State Drive), a semiconductor storage element such as a flash ROM (Read Only Memory), or other types of nonvolatile storage device. Further, the memory 11B can also include a RAM (Random Access Memory) constituting a work area for the processor 11A. The memory 11B stores the data to be processed by the control section 11, and a control program 118 to be executed by the processor 11A.

The processor 11A executes the control program 118 on an OS (Operating System). The OS is, for example, the so-called Mac (registered trademark) OS, or the Linux (registered trademark) OS.

In the present embodiment, there is described when the OS is the so-called Mac OS. The personal computer 1 is made by Apple Inc. The personal computer 1 is a so-called Macintosh (registered trademark) computer.

The processor 11A can be constituted by a single processor, or it is also possible to adopt a configuration in which a plurality of processors functions as the processor 11A. The processor 11A executes the control program 118 to control the personal computer 1.

Although the processor 11A executes the control program 118 to control the personal computer 1 in the present embodiment, it is possible for the control section 11 to execute the processing with a function implemented in an ASIC (Application Specific Integrated Circuit), or to perform signal processing with a signal processing circuit to execute the processing.

The control program 118 corresponds to an example of a “print control program.”

The control section 11 is provided with a reception section 111, a display control section 112, a determination section 113, an annunciation section 114, a correction section 115, a print data storage section 116, and a settable range storage section 117. The processor 11A executes the control program 118 to thereby function as the reception section 111, the display control section 112, the determination section 113, the annunciation section 114, and the correction section 115, and to thereby make the memory 11B function as the print data storage section 116 and the settable range storage section 117.

The print data storage section 116 stores print data to be output to the printer 2. The print data includes a setting item, and the identification information for identifying the printer 2 to which the setting item is set. The setting item includes a width and a length of the print sheet on which an image is formed. The identification information for identifying the printer 2 is, for example, name information assigned to the printer 2 by the user. The name information is stored in the print data storage section 116 in association with the IP address of the printer 2.

The settable range storage section 117 stores a printable range in association with the identification information for identifying the printer 2.

The printable range represents a range of a size of the print sheet which can be printed by the printer 2. The printable range is information related to the setting values of the setting item, and includes, for example, width information and length information. The width information represents the width of the print sheet which can be printed by the printer 2. The length information represents the length of the print sheet which can be printed by the printer 2. The printable range is stored as text information.

The reception section 111 receives input of the print command, the setting item, and the identification information for identifying the printer 2 to which the setting item is set via the input mechanism 12 using character input.

The print command is a command for instructing the printer 2 to perform printing.

The setting item represents, for example, the width and the length of the print sheet. The setting item can be one of the width and the length of the print sheet, or it is possible to adopt both of the width and the length of the print sheet as the setting item.

The reception section 111 receives the fact that a display key of the keyboard in the input mechanism is held down.

The display key is, for example, a TAB key. The display key is held down by the user when displaying the settable ranges related to the setting values of the setting item on the LCD of the display mechanism 13.

The display key corresponds to an example of a “first key.”

The reception section 111 receives the fact that a deletion key of the keyboard in the input mechanism 12 is held down.

The deletion key is, for example, the TAB key. The deletion key is held down by the user when deleting the display of the settable ranges related to the setting values of the setting item.

The deletion key corresponds to an example of a “second key.”

Although the display key and the deletion key are the same in the present embodiment, this is not a limitation. It is possible for the deletion key to be a key different from the display key. For example, the display key can be an F9 key, and the deletion key can be an F10 key.

Although the display key and the deletion key correspond to the TAB key in the present embodiment, this is not a limitation. It is sufficient for each of the display key and the deletion key to be a key set in advance. For example, the display key can be an ESC key, and the deletion key can be a PAUSE key.

The reception section 111 receives an input value corresponding to each of the setting values of the setting item via the input mechanism 12. The reception section 111 receives input of the input value of, for example, at least one of the width and the length of the print sheet.

When the reception section 111 receives the fact that the display key has been held down, the display control section 112 displays the settable ranges of the setting values of the setting item on the LCD of the display mechanism 13.

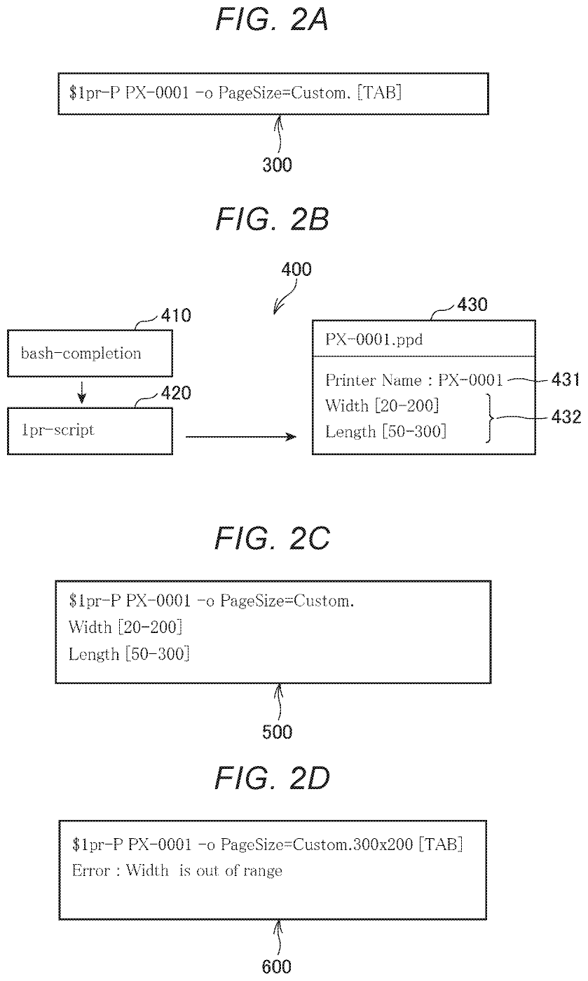

The “settable range” will be described later with reference to FIG. 2C.

When the reception section 111 receives the fact that the display key has been held down, the display control section 112 deletes the display of the settable ranges related to the setting values of the setting item on the LCD.

The determination section 113 determines whether or not the input values received by the reception section 111 are included in the respective settable ranges. The input values respectively represent, for example, the width and the length of the print sheet.

The settable ranges include, for example, a settable range of the width of the print sheet, and a settable range of the length of the print sheet.

When the determination section 113 determines that the input values received by the reception section 111 are not included in the respective settable ranges, the annunciation section 114 announces that erroneous input has been made.

For example, when the determination section 113 has determined that the input values received by the reception section 111 are not included in the respective settable ranges, the annunciation section 114 displays an error message representing the fact that the input values are erroneous input values not included in the respective settable ranges on the LCD of the display mechanism 13.

The error message is, for example, the character string “Input value of sheet width input is out of settable range.”

When the determination section 113 has determined that the input values received by the reception section 111 are not included in the respective settable ranges, the annunciation section 114 outputs a sound representing the fact that the input values are the erroneous input values not included in the respective settable ranges from the speaker of the sound output mechanism 14. Regarding the display on the LCD of the display mechanism 13 and the output from the speaker of the sound output mechanism 14, it is possible to perform either one of the display and the sound output, or it is also possible to perform both of the display and the sound output.

The correction section 115 has a correction function of correcting the input value received. The correction function is set in advance by the user, and when the correction function is enabled, a correction is performed on the input value received. When the correction function is disabled, the correction is not performed on the input value received. The settings of the enabled state and the disabled state are switched by the user in accordance with input in the reception section 111.

When the correction section 115 has corrected the input value received by the reception section 111, the annunciation section 114 announces the fact that the input value received by the reception section 111 has been corrected.

For example, when the correction section 115 has corrected the input value received by the reception section 111, the annunciation section 114 displays a message representing the fact that the input value received by the reception section 111 has been corrected on the LCD of the display mechanism 13.

The message is, for example, the character string “the input value of the sheet width input was corrected into the setting value of 200 mm.”

When the determination section 113 has determined that the input values received by the reception section 111 are not included in the respective settable ranges, the correction section 115 corrects each of the input values received by the reception section 111 into a maximum value or a minimum value in the corresponding settable range as the setting value based on the input values received by the reception section 111.

For example, when the input value received by the reception section 111 is larger than the maximum value in the settable range, the correction section 115 corrects the input value received by the reception section 111 into the maximum value in the settable range as the setting value. For example, when the input value received by the reception section 111 is smaller than the minimum value in the settable range, the correction section 115 corrects the input value received by the reception section 111 into the minimum value in the settable range as the setting value.

Then, a specific example of the processing of the control section 11 will be described with reference to FIG. 2A through and FIG. 2D.

FIG. 2A is a screen diagram showing an example of a settable range display instruction 300.

The settable range display instruction 300 represents an example of a command line input by the user as the CUI.

The character string “lpr” represents an example of a print command. The character string “PX-0001” represents an example of the identification information for identifying the printer 2. The character string “PageSize” represents the size of the print sheet as an example of the setting item. The character string “[TAB]” represents the fact that the TAB key has been held down. It should be noted that the character string “[TAB]” is not displayed on the LCD of the display mechanism 13.

Since the TAB key as an example of the display key is held down, the display control section 112 displays the settable ranges of the setting values of the size of the print sheet as the setting item on the LCD of the display mechanism 13 as shown in FIG. 2C.

FIG. 2B shows a configuration 400 for the display control section 112 to display the settable ranges of the setting values of the size of the print sheet on the LCD when the TAB key has been held down.

This processing is configured by bash-completion 410 implemented in “bash.” By using the bash-completion 410, when the user inputs a command and then holds down the TAB key, a script corresponding to the command is executed, and it is possible to perform interpolation of the command itself and display of candidates of parameters.

As shown in FIG. 2B, a script (lpr-script) 420 associated with the lpr command is invoked by the bash-completion 410. A setting file PX-0001.ppd 430 for the printer corresponding to the identification information “PX-0001” of the printer 2 thus input is retrieved to obtain the settable size of the print sheet, and then the settable size of the print sheet is displayed on the LCD.

The setting file PX-0001.ppd 430 is stored in the settable range storage section 117. The setting file PX-0001.ppd 430 associates the printer name 431 and the settable size 432 of the print sheet with each other. The printer name 431 is “PX-0001.”

The settable size of the print sheet is, for example, “Width [20-200],” “Length [50-300].” The settable width of the print sheet is no smaller than 20 mm and no larger than 200 mm, and the settable length of the print sheet is no smaller than 50 mm and no larger than 300 mm.

FIG. 2C is a screen diagram showing an example of settable ranges 500. As shown in FIG. 2C, the settable ranges 500 are displayed as “Width [20-200]” and “Length [50-300].” It is possible for the user to set the desired sheet size with reference to the settable side of the print sheet displayed.

FIG. 2D is a screen diagram showing an example of an error message 600.

The determination section 113 determines whether or not the input values received by the reception section 111 are included in the respective settable ranges. When the determination section 113 has determined that the input values received by the reception section 111 are not included in the respective settable ranges, the annunciation section 114 displays the error message representing the fact that the erroneous input has been made on the LCD of the display mechanism 13.

The determination section 113 determines whether or not the width of the print sheet and the length of the print sheet received by the reception section 111 are included in the settable size of the print sheet. In the settable size of the print sheet, the width of the print sheet is no smaller than 20 mm and no larger than 200 mm, and the settable length of the print sheet is no smaller than 50 mm and no larger than 300 mm.

As shown in FIG. 2D, the user inputs the input value of “300” mm as the width of the print sheet, and inputs the input value of “200” mm as the length of the print sheet.

In this case, the determination section 113 determines that the width of the print sheet input by the user is not included in the settable size of the print sheet.

The annunciation section 114 displays the error message 600 representing the fact that the width of the print sheet input is not included in the settable size of the print sheet. In FIG. 2D, there is displayed the character string “Error: Width is out of range.”

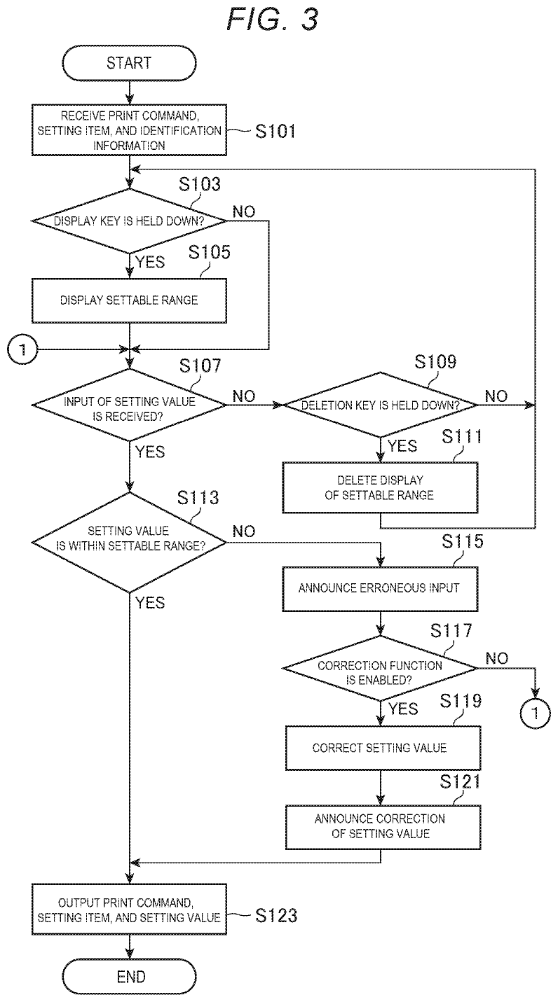

FIG. 3 is a flowchart showing an example of processing in the control section 11.

As shown in FIG. 3, in the step S101, the reception section 111 receives the print command, the setting item, and the identification information of the printer 2.

Then, in the step S103, the reception section 111 determines whether or not the display key has been held down.

When the reception section 111 has determined that the display key has not been held down (NO in the step S103), the process proceeds to the step S107. When the reception section 111 has determined that the display key has been held down (YES in the step S103), the process proceeds to the step S105.

In the step S105, the display control section 112 displays the settable ranges of the setting values of the setting item on the LCD of the display mechanism 13.

Then, in the step S107, the reception section 111 determines whether or not the input of the setting values of the setting item have been received as the input values.

When the reception section 111 has determined that input of the setting values of the setting item has been received (YES in the step S107), the process proceeds to the step S113. When the reception section 111 has determined that the input of the setting values of the setting item has not been received (NO in the step S107), the process proceeds to the step S109.

In the step S109, the reception section 111 determines whether or not the deletion key has been held down.

When the reception section 111 has determined that the deletion key has not been held down (NO in the step S109), the process returns to the step S103. When the reception section 111 has determined that the deletion key has been held down (YES in the step S109), the process proceeds to the step S111.

In the step S111, the display control section 112 deletes the display of the settable ranges of the setting values of the setting item. Subsequently, the process returns to the step S103.

When the reception section 111 has determined that the input values have been received as the input of the setting values of the setting item (YES in the step S107), the determination section 113 determines in the step S113 whether or not the input values received by the reception section 111 are included in the respective settable ranges.

When the determination section 113 has determined that the input values received by the reception section 111 are included in the respective settable ranges (YES in the step S113), the process proceeds to the step S123 adopting the input values as the setting values. When the determination section 113 has determined that the input values received by the reception section 111 are not included in the respective settable ranges (NO in the step S113), the process proceeds to the step S115.

In the step S115, the annunciation section 114 announces that the erroneous input has been made.

Then, in the step S117, the control section 11 determines whether or not the correction function is enabled.

When the control section 11 has determined that the correction function has not been enabled (NO in the step S117), the process returns to the step S107. When the control section 11 has determined that the correction function has been enabled (YES in the step S117), the process proceeds to the step S119.

In the step S119, the correction section 115 corrects each of the input values received by the reception section 111 into the maximum value or the minimum value in the corresponding settable range based on the input values received by the reception section 111.

Then, in the step S121, the annunciation section 114 announces the fact that the input values received by the reception section 111 have been corrected.

Then, after announcing the correction of the input values in the step S121, the input values thus corrected are fixed as the setting values, and then the process proceeds to the step S123. Alternatively, it is also possible to return to the step S107 in the state of keeping the input values thus corrected, then prompt the user to verify the setting values thus corrected, and then make the user perform input with a key such as a return key when the user has verified the input values thus corrected, and then fix the input values thus corrected as the setting values.

In the step S123, the control section 11 outputs the setting values of the setting item thus fixed based on the print command, the setting item, and the input values to the printer 2 corresponding to the identification information received in the step S101 to terminate the processing.

As described hereinabove, in the present embodiment, the control section 11 of the personal computer 1 receives the input of the print command, the setting item, and the identification information for identifying the printer 2 to which the setting item is set using the character input, and then displays the settable ranges related to the setting values of the setting item when the display key has been held down after the inputs of the print command, the setting item, and the identification information are received, and then receives the input of the setting values.

Therefore, since it becomes possible to receive the input of the setting values after the character string representing the settable ranges of the respective setting values of the setting item is displayed, it is possible to enhance the convenience of the user.

When the control section 11 of the personal computer 1 has received the input of the setting values, the control section 11 determines whether or not the input values thus received are included in the respective settable ranges.

Therefore, since whether or not the input values thus received are included in the respective settable ranges is determined, it is possible to prevent the input values not included in the respective settable ranges from being output to the printer 2 as the setting values.

When the control section 11 of the personal computer 1 has determined that the input values are not included in the respective settable ranges, the control section 11 announces that the erroneous input has been made.

Since it is announced that there has been made the erroneous input in which the input values are not included in the respective settable ranges when it has been determined that the setting values the input of which has been received are not included in the respective settable ranges, it is possible for the user to easily check that the setting values are not included in the respective settable ranges. Therefore, it is possible to enhance the convenience of the user.

As the annunciation of the fact that the erroneous input has been made, there is adopted at least one of the display of the error message and the output of the sound representing the erroneous input.

Since at least one of the display of the error message and the output of the sound representing the erroneous input is adopted as the annunciation of the fact that the erroneous input has been made, it is possible for the user to easily check that the setting values are not included in the respective settable ranges. Therefore, it is possible to enhance the convenience of the user.

When the control section 11 of the personal computer 1 has determined that the input values are not included in the respective settable ranges, the control section 11 corrects each of the input values into the maximum value or the minimum value in the corresponding settable range.

Since the input values are each corrected into the maximum value or the minimum value in the corresponding settable range when it has been determined that the input values are not included in the respective settable ranges, it is possible to appropriately correct the setting values. Therefore, it is possible to enhance the convenience of the user.

When the input values have been corrected, the control section 11 of the personal computer 1 performs display of showing the fact that the input values have been corrected.

Since it is displayed that the input values have been corrected when the input values have been corrected, it is possible for the user to easily check that the input values have been corrected. Therefore, it is possible to enhance the convenience of the user.

When the deletion key has been held down in the state in which the settable ranges of the setting values of the setting item are displayed, the control section 11 of the personal computer 1 deletes the settable ranges of the setting values of the setting item.

By holding down the deletion key, it is possible for the user to delete the display of the settable ranges. Therefore, it is possible to enhance the convenience of the user.

The setting item corresponds to at least one of the width and the length of the print sheet.

Therefore, since the input of the setting values is received in the state in which the character string representing the settable range of the setting value of at least one of the width and the length of the print sheet is displayed, it is possible to enhance the convenience of the user.

The control program 118 of the control section 11 of the personal computer 1 makes the processor 11A function as the reception section 111 for receiving the input of the print command, the setting item, and the identification information for identifying the printer 2 to which the setting item is set using the character input, and the display control section 112 for displaying the settable ranges related to the setting values of the setting item when the display key is held down, and the reception section 111 receives the input of the setting values.

Therefore, since it becomes possible to receive the input of the setting values after the character string representing the settable ranges of the respective setting values of the setting item is displayed, it is possible to enhance the convenience of the user.

The present disclosure is not limited to the configuration of the embodiment described above, but can be implemented in a variety of aspects within the scope or the spirit of the present disclosure.

Although the setting item corresponds to the width of the print sheet and the length of the print sheet in the present embodiment, this is not a limitation. It is sufficient for the setting item to be an item which defines a setting content related to printing. For example, it is possible for the setting item to be an item representing selection between single-side printing and both-side printing.

Although the character string representing the settable range is displayed in the display screen of the lpr command input by the user and so on in the present embodiment, this is not a limitation. It is possible to display the character string representing the settable range in a separate window from the display screen of the lpr command input by the user and so on.

At least a part of the functional blocks shown in FIG. 1 can be realized by hardware, or can also be provided with a configuration realized by hardware and software, and the present disclosure is not limited to the configuration of arranging the independent hardware resources in the same manner as shown in the drawing.

Although the control program 118 to be executed by the processor 11A of the control section 11 of the personal computer 1 is stored in the memory 11B, it is possible for the control program 118 to be stored in an HDD or the like.

The processing units of the flowchart shown in FIG. 3 are obtained by dividing the processing of the control section 11 of the personal computer 1 in accordance with major processing contents in order to make the processing of the control section 11 easy to understand. The scope of the present embodiment is not limited by the way of the division or the names of the processing units shown in the flowchart in FIG. 3. The processing of the control section 11 can be divided into a larger number of processing units, or can also be divided so that one processing unit includes a larger amount of processing in accordance with the processing contents. The processing sequence of the flowchart described above is not limited to the illustrated example.

The print control method in the personal computer 1 can be realized by making the processor 11A of the control section 11 of the personal computer 1 execute the control program 118 corresponding to the print control method in the personal computer 1. It is also possible to record the control program 118 on a recording medium storing the control program 118 in a computer-readable manner. As the recording medium, there can be used a magnetic or optical recording medium, or a semiconductor memory device. Specifically, there can be cited a portable recording medium such as a flexible disk, a CD-ROM (Compact Disc Read Only Memory), a DVD (Digital Versatile Disc), a Blu-ray (registered trademark) disc, a magnetooptic disc, a flash memory, or a card-type recording medium, or a rigid recording medium. The recording medium can also be a RAM, or a nonvolatile storage device such as a ROM or an HDD as an internal storage device provided to the personal computer 1. It is also possible to realize the print control method of the personal computer 1 by storing the control program 118 corresponding to the print control method of the personal computer 1 in a server device or the like, and then downloading the control program 118 from the server device to the personal computer 1.

What is claimed is:

1. A print control method of controlling a printing device, the method comprising:
receiving input of a print command, a setting item, and identification information configured to identify the printing device to which the setting item is set using character input;
displaying, when a predetermined first key is held down after the input of the print command, the setting item, and the identification information is received, a settable range related to a setting value of the setting item; and
receiving input of the setting value.

2. The print control method according to claim 1, further comprising:
determining, when the input of the setting value is received, whether or not an input value received is included in the settable range.

3. The print control method according to claim 2, further comprising:
announcing, when it was determined that the input value failed to be included in the settable range, that there was made erroneous input in which the input value fails to be included in the settable range.

4. The print control method according to claim 3, wherein the announcing that there was made the erroneous input is at least one of display of an error message and output of a sound representing the erroneous input.

5. The print control method according to claim 2, further comprising:
correcting, when it was determined that the input value failed to be included in the settable range, the input value into one of a maximum value and a minimum value in the settable range.

6. The print control method according to claim 5, further comprising:
performing, after the input value is corrected, display representing that the input value is corrected.

7. The print control method according to claim 1, further comprising:
deleting, when a predetermined second key is held down in a state in which the settable range is displayed, the settable range.

8. The print control method according to claim 1, wherein the setting item corresponds to at least one of a width and a length of a print sheet.

9. A non-transitory computer-readable storage medium storing a print control program making a processor in a computer configured to control a printing device perform a print control method comprising:
receiving input of a print command, a setting item, and identification information configured to identify the printing device to which the setting item is set using character input;
displaying, when a predetermined first key is held down after the input of the print command, the setting item, and the identification information is received, a settable range related to a setting value of the setting item; and
receiving input of the setting value.

10. The non-transitory computer-readable storage medium according to claim 9, the print control method further comprising:
determining, when the input of the setting value is received, whether or not an input value received is included in the settable range.

11. The non-transitory computer-readable storage medium according to claim 10, the print control method further comprising:
announcing, when it was determined that the input value failed to be included in the settable range, that there was made erroneous input in which the input value fails to be included in the settable range.

12. The non-transitory computer-readable storage medium according to claim 11, wherein
the announcing that there was made the erroneous input is at least one of display of an error message and output of a sound representing the erroneous input.

13. The non-transitory computer-readable storage medium according to claim 10, the print control method further comprising:
correcting, when it was determined that the input value failed to be included in the settable range, the input value into one of a maximum value and a minimum value in the settable range.

14. The non-transitory computer-readable storage medium according to claim 13, the print control method further comprising:
displaying, after the input value is corrected, that the input value is corrected.

15. The non-transitory computer-readable storage medium according to claim 9, the print control method further comprising:
deleting, when a predetermined second key is held down in a state in which the settable range is displayed, the settable range.

16. The non-transitory computer-readable storage medium according to claim 9, wherein
the setting item corresponds to at least one of a width and a length of a print sheet.
